(19) United States
(12) Patent Application Publication
(10) Pub. No.: US 2003/0151738 A1
(43) Pub. Date: Aug. 14, 2003

(54) On time steam quality, temperature, and pressure measuring method and apparatus at the head of an injection well

(76) Inventor: Yaosheng Chen, Blacksburg, VA (US)

Correspondence Address: Yaosheng Chen, Bldg. D, 200 Country Club Drive, Blacksburg, VA, 24060, US

(21) Appl. No.: 10/075,470

(22) Filed: Feb. 13, 2002

(51) Int. Cl. G01J 1/00

(52) U.S. Cl. 356/213

(57) ABSTRACT

The present invention is a method and an apparatus for the purpose of monitoring steam quality, temperature, and pressure, all located at the head of an injection well; steam along with high temperature and pressure are applied towards extraction of dense oil. The space index of refraction, representing the status of the mixture ratio in regards to steam and water, determines steam quality; a fiber optic method is employed for the above-mentioned task. Sensors, in the optical fiber, possess capabilities to also measure the temperature and pressure status throughout the fluid. Continually operating in all weather conditions, without flow obstruction, the sensors directly contact the steam; high temperature and pressure ratio determination would be the resulting outcome. Signals temperature t, pressure p, steam quality ρ, are captured by the optical fiber sensors; the above referenced signals are subjected to opto-electric exchange and amplification prior to transmission by means of a cable, to a nearby control site. Once data reaches the control site, a computer, previously set up, can control an on-time release system. To achieve transmission by a satellite, an antenna installation, in connection to the computer, becomes an additional option. In a centralized injection case, only one apparatus will be required in a specific well; in a dispersed injection case, each well will require an apparatus. The method invented offers numerous advantages, a compact structure, low cost, and a level of high accuracy in regards to measurements.

### FIELD OF INVENTION

The present invention relates to on-line monitoring, opto-electric technology, and optics of the fiber sensors. Widespread applications pertaining to the extraction of dense oil and the geothermal energy, within an oil refinery or inside a turbo generator will be afforded by this said method; heavy-duty machinery utilizing steam as a power source will also benefit.

### BACKGROUND OF THE INVENTION

The initial steam injection method, invented during the 1970s, currently continues application in the extraction of dense oil. In further explanation, the steam utilized is the production of the boiler; temperature and pressure levels do not usually exceed 360° C. (680° F.) and 20 Mpa, respectively. Steam quality is equalized by admixing water located at the wellhead; temperature and pressure levels will fluctuate. If the applied steam quality exceeds normalcy, many negative consequences occur; oil layer breakdown, flow misdirection, and a decrease in output. In reverse, if the steam quality dips below a median level, flow ease of the dense oil will become difficult. Hence that therefore, the steam quality utilized must be monitored at all points in time. An optimal state of the extraction process is achievable by controlling steam quality.

The current existing method to determine steam quality requires a separator, transported by a machinery truck. Once the truck situates onto the working site, the fluid mixture consisting of steam and water is linked into the separator, which will break down the mixture into two individual phases. By measuring velocity, temperature and pressure of each of the two phases, steam quality can be extrapolated; the two individual phases will be combined into an original single state and is replaced into the well. The particular said separator does not possess capabilities to control the flow of two individual phases nor measure distances; problems occur such as errors and a low accuracy level. Coinciding, the aforementioned process of separating and re-combining the said liquids is not reversible. Closely examined, the named “separated single phases” reveal that the mixed state remains, whether it is water with steam or steam with water. Proven from use, the separator is not capable measuring zero steam quality (i.e. all is water), or all steam quality (i.e. all is steam). Further yet, the method in practice is not competent to distinguish to distinguish dissolving steam in water.

### SUMMARY OF THE INVENTION

The present invention is intelligent enough to overcome any shortfalls presented by the current separator; long-range measurement is achievable as well. On the basis of the invented apparatus three data collection methods are options, first hand accumulation at the work site, long-range (transmittable by cable), and by means of a satellite controlled indoors. The invented apparatus maintains a compact structure, installed on a long-term basis at the wellhead; analytical data is obtainable at any point in time.

### BRIEF DESCRIPTION OF THE DRAWINGS

The present invention may be best understood by way of the following description of a method employing the principles of the invention as illustrated in the accompanying drawings, in which:

FIG. 1 shows a structure diagram of the sensor of steam quality.

FIG. 2 displays the overall structure of the present invention.

REFERENCE NUMERALS IN DRAWING

| | |
|---|---|
| 1. | Sensor stand of optical fiber |
| 2. | Red copper washer |
| 3. | Heat-resistant stainless steel pipe |
| 4. | Optical fiber sensor |
| 4(a). | Steam quality sensor |
| 4(b). | Pressure sensor |
| 4(c). | Temperature sensor |
| 5. | Sealing washer |
| 6. | Stand for pressure transition |
| 7. | Standard Flange plate |
| 8. | Screw |
| 9. | Heat insulation washer |
| 10. | Heat reflected pipe |
| 11. | Radiator |
| 12. | Block end |
| 13. | Screw |
| 14. | Silicon rubber washer |
| 15. | Connective stand with heat insulation |
| 16. | Screw |
| 17. | Box of circuit plate |
| 18. | Convective radiator |
| 19. | Circuit plate |
| 20. | End cover |
| 21. | Supporting frame of plug |
| 22. | Cable plug |
| 23. | Cable |
| 24. | Transducer |
| 25. | Plug of computer notebook |
| 26. | Circuit transmitting joint for |
| | long-range control |
| 27. | Glass fiber-stuffing |
| 28. | Opto-electric transfer joint |
| 29. | Optical fiber |
| 30. | Stainless steel pipe |
| 31. | Nut |
| 32. | Lead washer |
| 33. | Sealing stand |
| 34. | Red copper washer |
| 35. | Probe of optical fiber |

FIG. 3 represents a block diagram of the circuit. The three signals obtained ρ, t, and p, are converted into stable simulated signals by the steps of opto-electric transfer and linear correction. The above-mentioned piece is to be installed into the upper portion of the circuit plate, then will be connected to a transducer by means of a cable. Included in the transducer is a circuit of the micro-processing unit; this unit will transmit the signal of steam/water ratio via A/D transfer as a finale.

The installation sketch diagram in the working site is displayed in FIG. 4. In further detail, many of the sensors, as a bulk, are installed onto the injection pipe. The transducer, installed into a junction box, maintains a power supply of 110 v/220 v at the work site location; furthermore, connected to a cable possessing a long-range data collection, transmission of controlled signals in a long-range are possible. An additional function of the transducer is to command four electromagnetic values located on the steam pipe and separate executive device.

### DETAILED DESCRIPTION

The present invention pertains to a method and an apparatus for monitoring of steam quality, temperature, and pressure on-line. Steam quality can be defined as

ρ=Quality of steam/quality of water+quality of steam.

In a dynamic condition, steam quality depends on temperature, pressure, and the velocity of steam inside a specified pipe. At this time, the dynamic equation of the two-phase flow is under construction. The quality of steam and its correlating change is expressed by a curve; composed from several data points collected by instantaneous measurements. Measuring the space refractive index of steam/water combined fluid by utilizing sensors of the optical fiber is the main principle of the invented method. It is assumed that the refractive index of water is 1.33, and steam 1.0. For a single phase, either water or steam in a pipe, refractive index fluctuations are not sensitive to the coordinating temperature and pressure; however steam is compressible. Fluctuations in density, pressure, and the refractive index can be neglected when gas remains in the flow condition. Also, it is known that the space refractive index of water/steam mixture does not correlate sensitivity towards temperature and pressure regarding the fluid inside a pipe; therefore the index is capable of representing the steam/water ratio of the analyzed object. Given, the value of the index n₂ is 1≦n₂≦1.33 (n₂=1 all is steam; n₂=1.33, all is water).

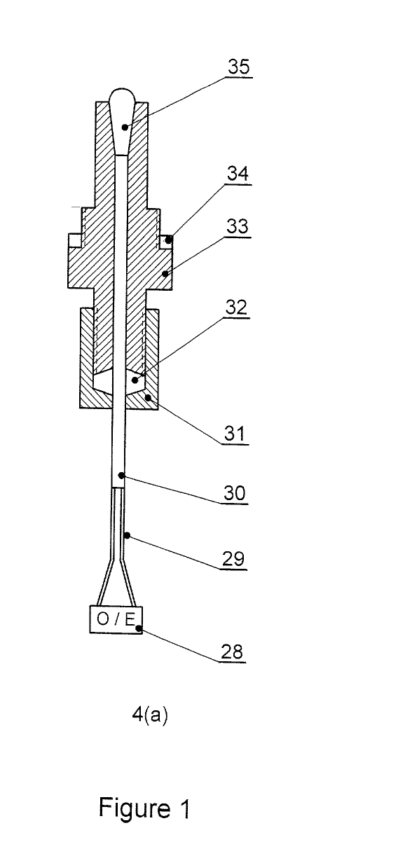

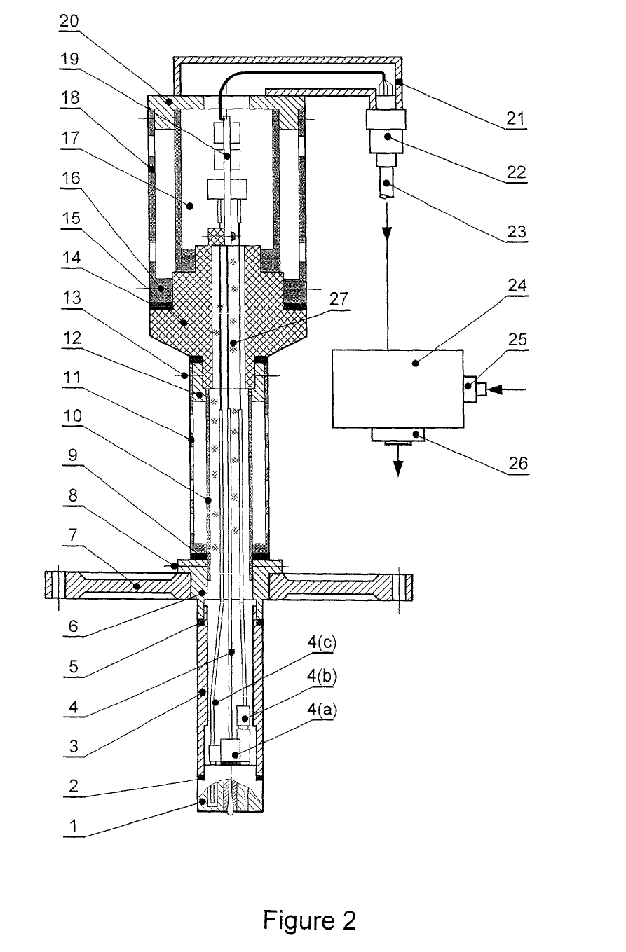

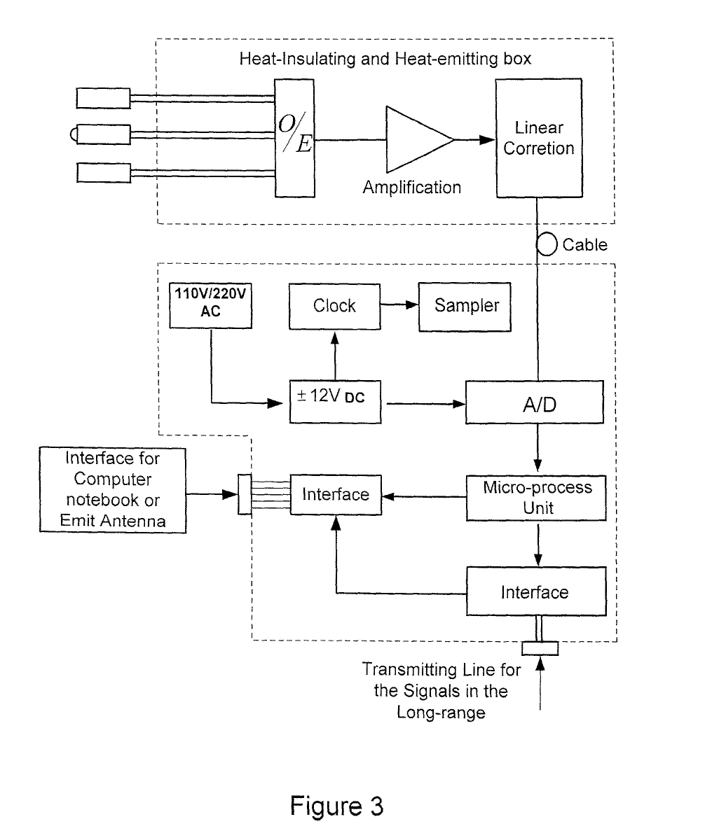

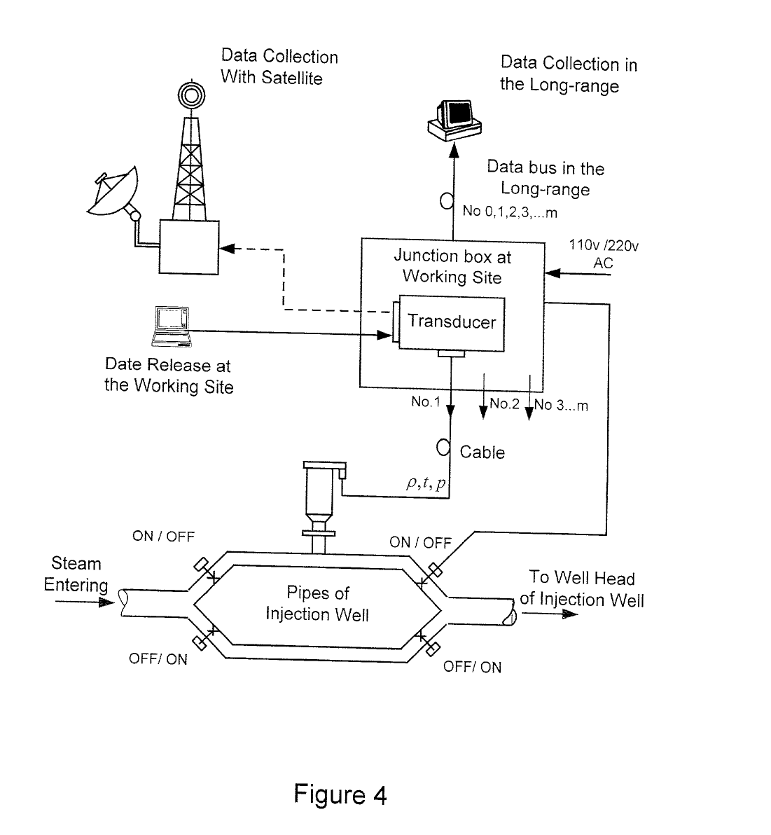

FIG. 1 displays the structure diagram of the steam quality 4(a) sensor. Light produced from the opto-electric transfer 28 transmits to the probe 35, which then comes into contact with an analyzed fluid, through an optical fiber. In a case where the incident angle of light θ₁ is less than the refractive angle of light θ₂[θ₂=sin⁻¹(n₂/n₁)], transmissivity of the said incident light, arbitrarily polarized, is expressed as the following

$$T = \frac{{n}_{2} cos {θ}_{2}}{{n}_{1} cos θ1} \{ [ \frac{2 sin {θ}_{2} cos {θ}_{1}}{sin ( {θ}_{2} + {θ}_{1} ) cos ( {θ}_{2} - {θ}_{1} )} ] + [ \frac{2 sin {θ}_{2} cos {θ}_{1}}{sin ( {θ}_{1} + {θ}_{2} )} ] \}$$

Where n₁ represents the refractive index of the probe, n₂ represents the space refractive index of steam/water-combined fluid θ₁ represents the incident angle of light, and θ₂ represents the refractive angle. In field use, the probe is constructed of blue gem; the tip of the gem's surface portrays a half-circular shape. The light reflected from the end of the probe R will be expressed as R£<<T≈1. As an additional step, the light reflected will enter into the opto-electric transfer 28; light is transformed into an electric signal, the aforementioned is now represented by the expression of the steam/water combined ratio. The wick/cover ratio of the optical fiber 29 is precisely 300 μm/ 420 μm. Installed together inside the stainless steel pipe, are two of the optical fibers; high temperature resistant glue is utilized to seal the said fibers jointly. The fragment of the optical fiber residing inside the pipe will be inserted into the sealing stand 33; the nut 31 is tightened together with the lead washer 32. At this point, the sealing stand 33 is installed into the sensor's stand 1 by employing a red copper washer, detailed in FIG. 2.

Similar structure characteristics of the pressure sensor 4(b) can be identified with that of the steam quality sensor. A diaphragm, located at the front end of the sensor gaps of 0.5˜2 mm from the optical fiber; when pressure is encountered, the gap is decreases. By determining the strength of the light transmitted, the corresponding pressure is known. Currently, the pressure sensor is widely accepted and available.

Referring to the temperature sensor, it is composed of quartz capillaries; the capillary walls are brushed with aluminum or gold film, possessing highly reflective properties. The determining temperature of the sensor fluctuates between room temperature and 400° C., widely accepted and available as well.

Installed onto the sensor stand 1 are the said sensors 4(a), 4(b), and 4(c). FIG. 2 displays a detailed drawing of the structure regarding the present invention's sensor; two sections exist: the cable 23 connects a transducer and a bulk of sensors, all. Four blocks compose the bulk of sensors. NO.1˜6 represents the high temperature block, directly entering the steam pipe; sealed by a Flange plate 7. NO. 8˜14 represents the temperature reducing block; the radiator 11 component possesses heat-emitting slots, constructed of stainless steel, the same as reflected pipe 10. NO.15 represents the heat insulation block, i.e. the third block of the body. The above-mentioned block is constructed of polytetrafluoroethane (PFE), and glass fibers throughout the center to prevent heat from emitting. The final fourth block of the bulk, NO.16˜20, includes opto-electric transfer and the circuit plate. Pipes, 17 and 18 are constructed of stainless steel; the periphery on both ends of pipe 18 possesses ventilating slots to reduce temperature by method of convection. The circuit plate 19 connects to the transducer by a cable 23; supported by the frame of plug 21 and the cable plug 22. The transducer 24 transmits steam quality temperature and pressure signals to a long-range control room throughout the circuit-transmitting joint 26. Included on one side of the transducer is a plug 25 utilized by the computer storage base, releasing data to the working site.

FIG. 3 represents the block diagram of the circuit. The three signals obtained from the fiber optical sensors, ρ, t, and p transmit to the transducer by means of a cable; methods of opto-electric transfer, amplification, and linear correction are applied. Once the above-mentioned steps occur, the digital signals, ρ, t, and p are accessible in the transducer via A/D transfer coinciding with the micro-processing unit. The following power sources, 24 V_{DC} or 12 V_{DC} utilized by the transducer, and 110 v/220 v, alternating, feeding to the junction box are readily available to the system as a whole. The present invention is capable of collecting the parameters of fluid inside the steam pipe and transmitting data to a long-range control room to be treated; based on the technology of steam injection.

FIG. 4 displays the installation sketch diagram to be utilized at the working site. Located at the head of each injection well is a steam pipe; composed of two separate sets of three-way pipes. In further detail, when data collection occurs, the signal, received from the long-range control room, is capable of directing the four electromagnetic valves located on the steam pipe. Electrical signals are transformed into digital signals, once obtained from the transducer of the system; a two-phase fluid, consisting of water and steam, flows throughout the invented apparatus before the above said step occurs. To release data the transducer connects to the computer notebook. If the operator is not present at the working site, signals will be automatically transferred to the long-range control room. As previously mentioned, the parameters of ρ, t, and p at each injection well at any desired moment, and pre-treated signals, are obtainable in the form of computer feedback, applied at the working site. The computer system's software depends upon oil extraction technology. Installed inside the junction box, are several transducers; assists the corresponding injection well to produce results individually or simultaneously.

The water/gas two-phase flow liquid is complex in structure. Within a horizontal pipe, two simplified states can exist: mixed and layer-separated. In the layer-separated state, water stations bottom side, and gas rises to the top. Upon entrance into a vertical injection well, a mixed state will become of the layer-separated. The space refractive index is capable of being measured in either said states or any necessary time. The obtained gas/water ratio, at a particular extraction moment, does not pertain to the phase status. With having stated the above, it is noted that the density of steam, however, relates to corresponding temperature and pressure; neglect is possible to occur. Assuming the light produced from the sensor head of the steam quality possesses a visual angle of 160°, and known is the occupied volume of steam and water, the steam quality value obtained at the extraction moment will be utilized as sole data.

From field practice, the present invention provides verifiable proof of capabilities to withstand and endure high temperature and pressure atmospheres all while providing accurate data; collection at the working site or long-range is possible. Another option is to receive data by satellite; a data emitting system will be an addition. Overall, the system error produced by the invented method is less than 3%.

What is claimed is:

1. An apparatus capable of monitoring on-line steam quality, temperature, and pressure at the head of the injection well, composed of a bulk of three optical fiber sensors and a transducer. The head of the sensor directly enters into the specified steam pipe, preventing blockage of any steam. The transducer, installed inside the junction box at the working site, is to be utilized by several surrounding wells. A cable connection links the sensor bulk and transducer together. The invented apparatus boasts the following three functions:
a. Long-range data collection transmitted through cables, connected to a combination box.
b. Release of data at the working site, initialized by a notebook compute; connected onto a special joint of the transducer.
c. Data collection with a satellite; a data emitting antenna is connected onto a special joint of the transducer as well.

2. The bulk, as stated in claim 1, is composed of four separate blocks: high temperature and pressure, heat-emitting and temperature reducing, heat insulation, and opto-electric elements, found in a natural cooling room. The first-mentioned block is constructed of heat-resistant stainless steel. Referring to the heat-emitting block, two layers of metal piping are applied; a highly reflective coating covers the surface. In further detail, the inner pipe, filled with glass fiber cloths, guides the optical fibers. Air holes surround the outer pipe allowing steam to flow through, reducing temperature. Summing up, the heat installation block is constructed out of polytetrafluoroethane (PFE). It is to be noticed that an air gap, 5˜15 mm, purposely exists between pipes.

3. The bulk as stated in claim 1 includes the following three sensors: steam quality, temperature, and pressure. The steam quality sensor is composed of two parallel optical fibers possessing a large core, connected by a blue gem probe. The two said fibers serve separate functions; one receives light, and one emits light. When light transmitted from the blue gem probe to the LED carries a wavelength measuring near infrared, the fluid state will be disturbed, determined by the light strength. The PIN probe, connected to the light-receiving fiber, will transmit the corresponding electric signal. The signal is then amplified and rectified before entering into the transducer, where A/D transfer and pattern discrimination will be carried out. The steam pressure sensor is composed of two parallel optical fibers possessing a large core as well; rests against an elastic diaphragm; which gaps 0.5˜2 mm from the optical fiber's end. When steam pressure fluctuates, the gap between the diaphragm and optical fiber is subjected to change as well, thus the PIN probe will accurately transmit the corresponding electric signal to the pressure of steam. After the aforementioned step occurs, including amplification and rectification, the signal enters into the transducer. The steam temperature sensor is composed of infrared optical fiber material. Of the optical fiber, one end is inserted into the selected steam pipe; the other connects to a thermoelectric probe. In a similar fashion, corresponding electric signals transmit simultaneously with temperature changes of the steam. The signal produced enters into the transducer, after amplification and rectification occurs.

4. Included inside the transducer, stated in claim 3, is a micro-processing unit; capable of functions such as A/D transfer, pattern discrimination, and sampler trigger. Signals ρ, t, and p, provided at the moment requested, will be relayed through long-range transmission, data release at the working site, or by satellite collection. The transducer provides a 12 v or 24 v direct power source for all said sensors. The direct current, to be supplied by the transducer, will be obtained from an AC transfer of 110 v/220 v inside the junction box, located at the working site.

5. The steam quality sensor, mentioned in claim 3, is capable of directly measuring steam quality, not obtained from conversion of temperature and pressure. A unique feature of the present invention is that the space refractive index n represents the two-phase fluid's state at a specified moment. The invented method is utilized to measure the quality of steam on-line, while maintaining a level of high accuracy.

6. The steam quality sensor, stated in claim 5, possesses a head constructed of blue or red gem; upholding a high level of endurance. The end of the above-mentioned probe takes on the shape of a semi-circle, cone, or lens. The surface of the probe's side maintains a taper of 1:10˜1:50. For sealing purposes at such high temperature and pressure levels, the probe is firmly stationed onto a stainless steel stand; wall thickness is greater than 1.5 mm.

7. In addition, to resolve the stated sealing dilemma in claim 6, a red copper washer will be placed at each joint of thread. The present invention is capable of withstanding the following conditions: temperature≦360° C. (680° F.), pressure≦20 Mpa.
